(19) United States
(12) Patent Application Publication
(10) Pub. No.: US 2007/0070588 A1
(43) Pub. Date: Mar. 29, 2007

(54) Display device turned off by inserting object

(75) Inventor: Hsien-Tang Lin, Taichung City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/494,867

(22) Filed: Jul. 28, 2006

(30) Foreign Application Priority Data
Aug. 19, 2005 (TW) TW94128369

(51) Int. Cl. G06F 1/16

(52) U.S. Cl. 361/681

(57) ABSTRACT

A display device comprises a main body, an accommodating device disposed on the main body, and a switch disposed on the main body and positioned in the accommodating device. When an object is inserted into the accommodating device, the switch is actuated to turn the display device off, and when the object is removed, the switch is actuated to turn the display device on.

### BACKGROUND

The invention relates to a display device, and in particular to a display device turned off by inserting an external object into an accommodating bay thereof.

Conventional display devices, either cathode-ray-tube display (CRT) or liquid crystal display (LCD), have an independent power switch to turn the display on or off. FIG. 1 shows a conventional LCD device. When the main switch 10 is engaged, the display device 100 is turned on, and when it is disengaged, the display device 100 is turned off.

### SUMMARY

An embodiment of a display device of the invention comprises a main body, an accommodating device disposed on the main body, and a switch disposed on the main body and positioned in the accommodating device. When an object is inserted into the accommodating device, the switch is actuated to turn the display device off, and when the object is removed, the switch is actuated to turn the display device on.

The accommodating device comprises an accommodating element joined to the main body to form an accommodating bay. The switch is disposed on the main body and positioned in the accommodating bay.

The accommodating element can be integrally formed with the main body.

### BRIEF DESCRIPTION OF THE DRAWINGS

The invention can be more fully understood by reading the subsequent detailed description and examples with references made to the accompanying drawings, wherein:

FIG. 1 is a schematic view of a conventional display device;

FIG. 2 is a schematic view of an embodiment of a display device;

FIG. 3 is an enlarged view of portion A of FIG. 2;

FIG. 4 is a schematic view showing a power switch mounted on the main body of the display device of the invention;

FIGS. 5a, 5b are schematic views of another embodiment of the invention; and

FIG. 6 is a block diagram shows relationship of the main switch, the power switch and the object(mouse).

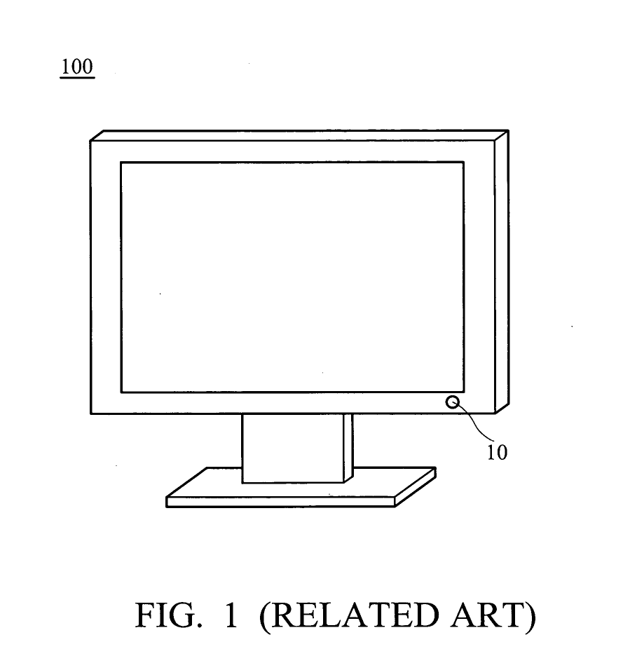

### DETAILED DESCRIPTION

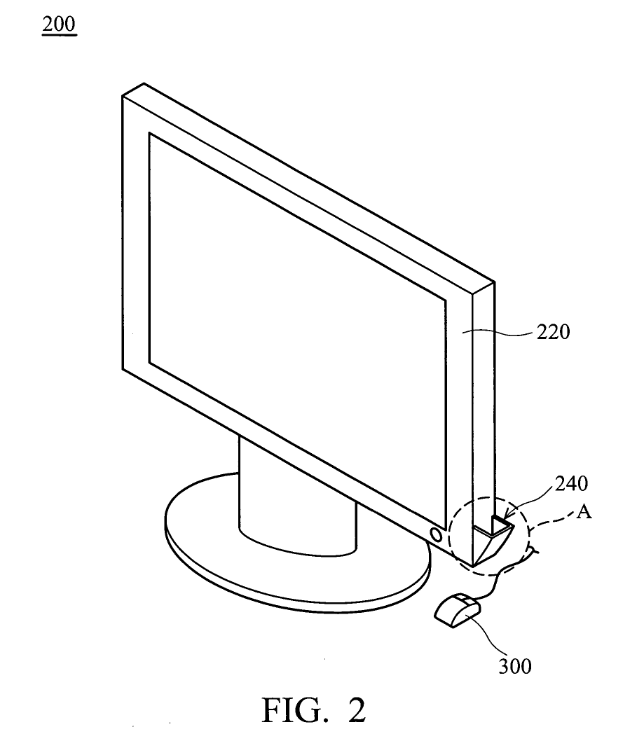

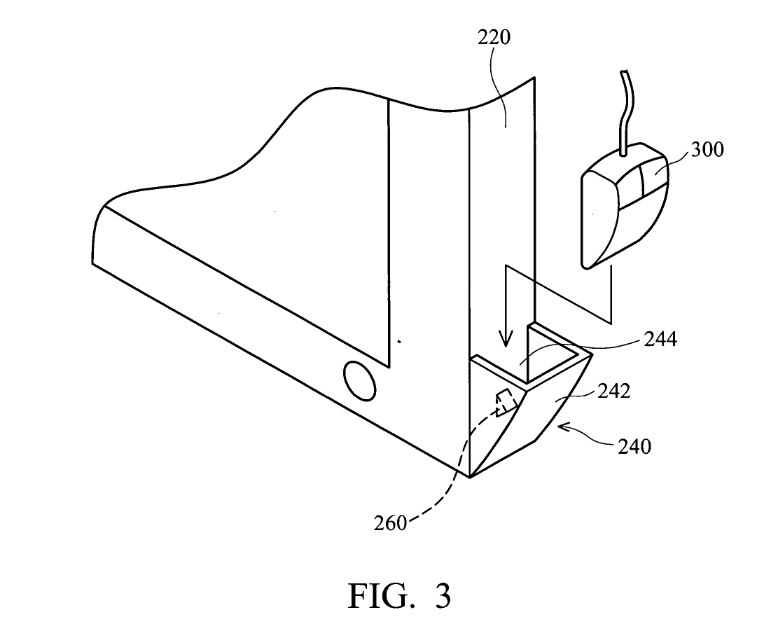

Referring to FIG. 2, a display device 200 comprises a main body 220 and an accommodating device 240 disposed on one lateral side of the main body 220. A mouse 300 can be received in the accommodating device 240. FIG. 3 is an enlarged view of portion A of FIG. 2. The accommodating device 240 comprises an accommodating element 242 with U-shaped cross section. The accommodating element 242 is fixed to the lateral wall of the main body 220 to form an accommodating bay 244.

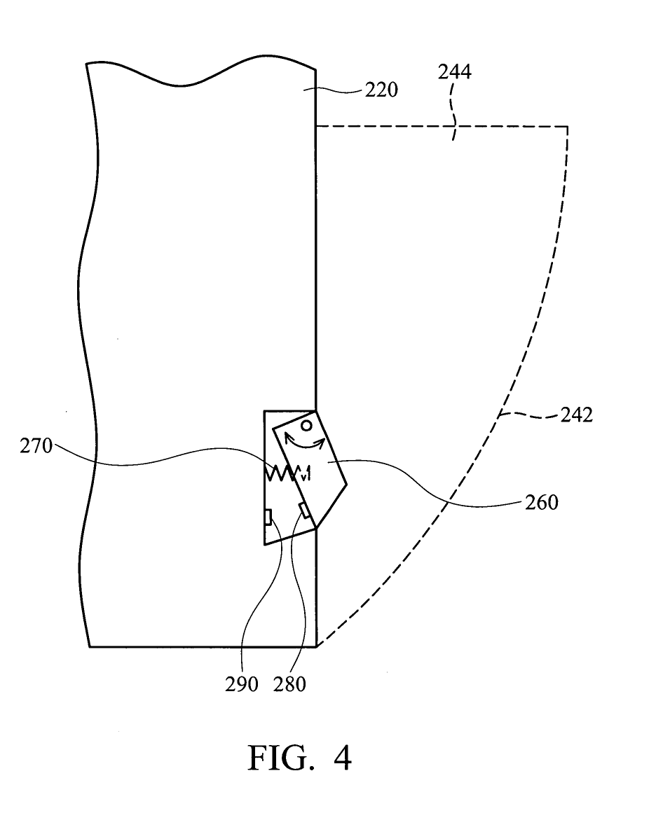

A power switch 260 is disposed on the lateral wall of the main body 220 and positioned in the accommodating bay 244 as shown in FIG. 4. The power switch 260 is joined with the main body 220 via a compression spring 270. When the mouse 300 is inserted into the accommodating bay 244, the weight of the mouse 300 pushes the switch 260 and compresses the compression spring 270, whereby a contact 280 on the power switch 260 contacts a contact 290 on the main body 220 to turn the display device 200 off. When the mouse 300 is removed, potential of the compression spring 270 lifts the power switch 260 to separate the contacts 280 and 290 to turn the display device 200 on.

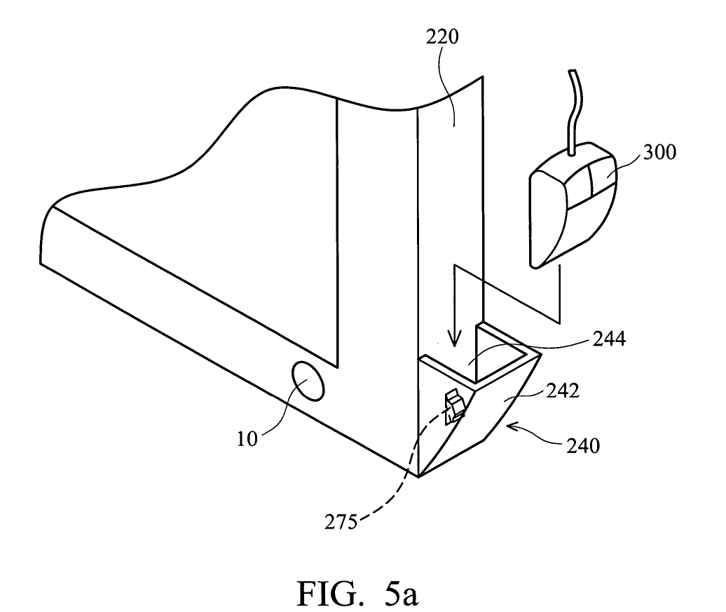

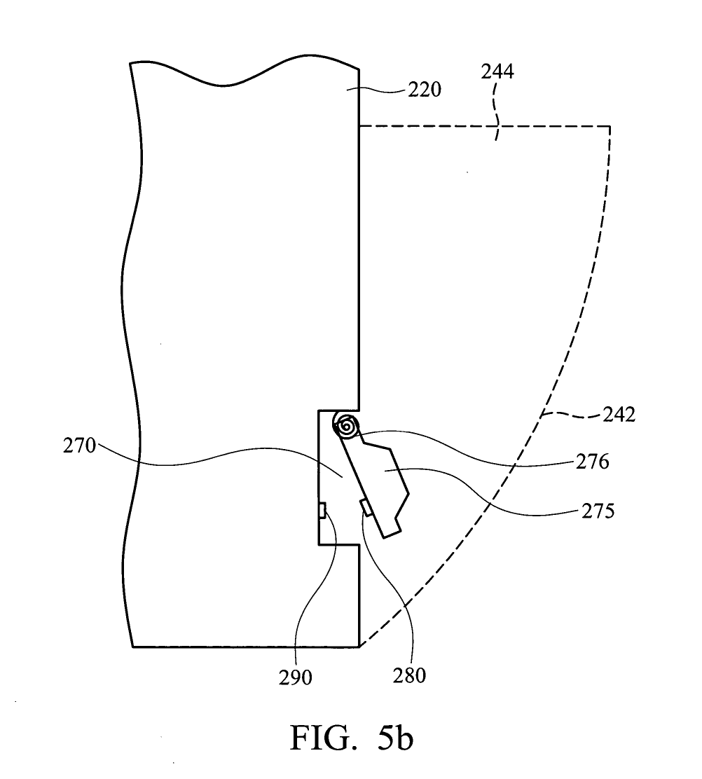

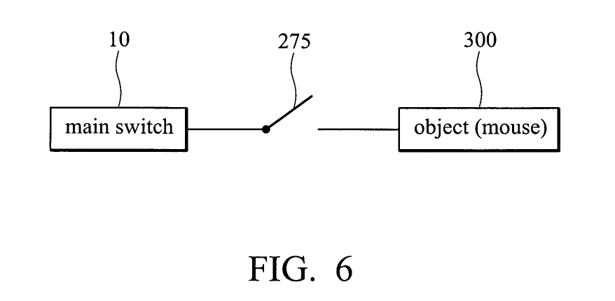

FIGS. 5a and 5b depict another embodiment of the invention. In this embodiment, a power switch 275 is disposed on the lateral wall of the main body 220. When the mouse 300 is inserted into the accommodating bay 244, the weight of the mouse 300 pushes the power switch 275 and rotate a volute spring 276, whereby the contact 280 contacts the contact 290 to turn off the display device 200. When the mouse 300 is removed, the power switch 275 is lifted by the potential of the volute spring 276 to turn the display device 200 on. FIG. 6 shows the correlation between the main switch 10, the power switch 275 and the mouse 300.

The structure of the power switch is not limited to the described. The structure disposed in such a manner that display device is turned off by inserting an object is within the scope of the invention.

The object which is inserted into the accommodating bay is not limited to a mouse. Mobile phones, PDAs or small calculators are also applicable.

The accommodating device 240 can be disposed in other positions other than the lateral wall, such as front or back of the display device.

The accommodating element 242 can be shapes other than a U-shape, for example a curved shape.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a main body;
an accommodating device disposed on the main body; and
a switch disposed on the main body and positioned in the accommodating device, wherein when an object is inserted into the accommodating device, the switch is actuated to enable the display device to be in a first state, and when the object is removed, the switch is actuated to enable the display device to be in a second state.

2. The display device as claimed in claim 1, wherein the accommodating device comprises an accommodating element joined to the main body to form an accommodating bay.

3. The display device as claimed in claim 2, wherein the switch is disposed on the main body and positioned in the accommodating bay.

4. The display device as claimed in claim 3, wherein the accommodating element is integrally formed with the main body.

5. The display device as claimed in claim 1, wherein the object is a mouse.

6. The display device as claimed in claim 1, wherein when the display device is in the first state, power is turned off, and when the display device is in the second state, power is turned on.

7. A method of actuating a display device comprising an accommodating device and a switch in the accommodating device, comprising the following steps:
inserting an object into the accommodating device to actuate the switch to enable the display device to be in a first state;
removing the object from the accommodating device to actuate the switch to enable the display device to be in a second state.

8. The method as claimed in claim 7, wherein when the display device is in the first state, power is turned on, and when the display device is in the second state, power is turned off.
